(19) United States
(12) Patent Application Publication
(10) Pub. No.: US 2006/0107327 A1
(43) Pub. Date: May 18, 2006

(54) Methods and apparatus for enforcing application level restrictions on local and remote content

(76) Inventors: Stephen A. Sprigg, Poway, CA (US); Laurence Lundblade, San Diego, CA (US)

Correspondence Address: QUALCOMM, INC, 5775 MOREHOUSE DR., SAN DIEGO, CA, 92121, US

(21) Appl. No.: 10/990,664

(22) Filed: Nov. 16, 2004

(51) Int. Cl. H04N 7/16

(52) U.S. Cl. 726/26

(57) ABSTRACT

Methods and apparatus for enforcing application level restrictions on local and remote content rendered on a device. One method comprises receiving a permissions list associated with the content, receiving a content descriptor that identifies the content, and receiving a modification detection indicator that was created by an authority, wherein the modification detection indicator binds the permissions list and the content descriptor. The method further comprises retrieving the content identified by the content descriptor, and rendering the content on the device, wherein the content is restricted based on the permissions list.

### BACKGROUND

I. Field

The present invention relates generally to the operation of data networks, and more particularly, to methods and apparatus for enforcing application level restrictions on local and remote content rendered on a device.

II. Description of the Related Art

Advances in technology have resulted in the development and deployment of extensive data networks. These networks include both public data networks, such as the Internet, and specialized networks, such as wireless telecommunication networks. Users of these networks have the ability to access a wide variety of information and services that are available as network resources.

One example where there is an increasing demand for network resources is in wireless network environments. In wireless environments, a variety of wireless devices, such as wireless telephones, personal digital assistants (PDAs), and paging devices, communicate over a wireless network. The wireless network may also include network servers that operate to provide various network resources to the wireless devices. Furthermore, the wireless networks may also be coupled to a public network, such as the Internet, so that resources on the public network can be made available to the wireless devices on the wireless network.

Typically, a wireless device may download and store an application program or multimedia content using the wireless network. The application or content may be downloaded for free or purchased by the user of the wireless device, who effectively obtains the rights to use the application or content for an unlimited, fixed, or usage count based expiration period.

However, downloaded content has the potential to damage or delete information, or otherwise compromise the device that it is running on. For example, the content may include scripting, animations, or other commands that may delete files, generate pop-ups, create loud sounds or display inappropriate content. Thus, device users cannot fully trust that downloaded applications or content will not access files or other personal information on their devices, or perform other undesirable functions.

One technique that has been used to restrict downloaded content is to allow the device user to set general controls regarding device operation. For example, device users can block all scripting from functioning on the device. Unfortunately, this technique forces the device user to make decisions about how and when to use these types of controls. In most cases, device users are not well informed or do not have enough knowledge to make these decisions. Furthermore, setting general device controls may result in device users being unable to access content they would like to receive or unable to obtain certain application functionality without exposing the device to potential compromise.

Therefore, what is needed is a system to enforce application level restrictions on applications or content available to a device over a network. The system should allow the device user to access a wide range of network resources without having to worry about downloading unrestricted content that may compromise the device or corrupt valuable device information. The system should also operate without requiring the device user to make decisions about the types of restrictions that are required, or having to know which content requires specific restrictions. As a result, device users can be confident that the content they download will not damage or corrupt their devices or personal information stored on their devices.

### SUMMARY

In one or more embodiments, a restriction system is provided to enforce application level restrictions on local and remote content rendered on a device. In one embodiment, the restriction system comprises a content descriptor, a permissions list and a modification detection indicator, (i.e., a digital signature) that binds the content descriptor and the permissions list. In one embodiment, the content descriptor comprises actual content data to be rendered on the device, and in another embodiment, the content descriptor identifies the location of an application or multimedia content that is to be downloaded and rendered on the device. The permissions list is used by the restriction system to restrict the rendering, display and execution of the downloaded application or content. For example, the permissions list is used to control the access rights and privileges of the application or content so that systems, features, settings, and information on the wireless device are protected against unauthorized access by the application or content. An authority, such as a device service provider or other entity, approves the permissions list and generates the modification detection indicator that binds the permissions list and the content descriptor.

In one embodiment, a method is provided for use in a device to enforce restrictions on content render on the device. The method comprises receiving a permissions list associated with the content, receiving a content descriptor that identifies the content, and receiving a modification detection indicator that was created by an authority, wherein the modification detection indicator binds the permissions list and the content descriptor. The method further comprises retrieving the content identified by the content descriptor, and rendering the content on the device, wherein the content is restricted based on the permissions list.

In another embodiment, a device for rendering content is provided. The device comprises receiving logic that operates to obtain a permissions list, content descriptor, and a modification detection indicator that was created by an authority. The device also comprises rendering logic that operates to verify the modification detection indicator, obtain content identified by the content descriptor, and render the content on the device, wherein the content is restricted based on the permissions list.

In another embodiment, a device is provided that operates to enforce restrictions on rendered content. The device comprises means for receiving a permissions list associated with the content, means for receiving a content descriptor that identifies the content, and means receiving a modification detection indicator that was created by an authority, wherein the modification detection indicator binds the permissions list and the content descriptor. The device also comprises means for retrieving the content identified by the content descriptor, and means for rendering the content on the device, wherein the content is restricted based on the permissions list.

In another embodiment, a computer-readable media is provided that comprises instructions, which when executed by a processor in a wireless device, enforce restrictions on content rendered by the device. The computer readable media comprises instructions for receiving a permissions list associated with the content, instructions for receiving a content descriptor that identifies the content, and instructions receiving a modification detection indicator that was created by an authority, wherein the modification detection indicator binds the permissions list and the content descriptor. The computer-readable media also comprises instructions for retrieving the content identified by the content descriptor, and instructions for rendering the content on the device, wherein the content is restricted based on the permissions list.

In another embodiment, a method is provided for generating a content package that is used to enforce restrictions on content rendered on a device. The method comprises receiving a permissions list associated with the content, receiving a content descriptor that describes the content, and generating a modification detection indicator that binds the permissions list and the content descriptor.

In another embodiment, apparatus is provided for generating a content package that is used to enforce restrictions on content rendered on a device. The apparatus comprises receiving logic that operates to receive a permissions list associated with the content, and a content descriptor that describes the content. The apparatus also comprises generating logic that operates to generate a modification detection indicator that binds the permissions list and the content descriptor.

In another embodiment, apparatus is provided for generating a content package that is used to enforce restrictions on content rendered on a device. The apparatus comprising means for receiving a permissions list associated with the content, means for receiving a content descriptor that describes the content, and means for generating a modification detection indicator that binds the permissions list and the content descriptor.

In another embodiment, a computer-readable media is provided that comprises instructions, which when executed by a processor, generate a content package that is used to enforce restrictions on content rendered on a device. The computer readable media comprises instructions for receiving a permissions list associated with the content, instructions for receiving a content descriptor that identifies the content, and instructions generating a modification detection indicator that binds the permissions list and the content descriptor.

Other aspects, advantages, and features of the present invention will become apparent after review of the hereinafter set forth Brief Description of the Drawings, Detailed Description of the Invention, and the Claims.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 shows a data network that comprises one embodiment of a restriction system to enforce application level restrictions on local and remote content rendered on a wireless device;

FIG. 2 shows a functional diagram of one embodiment of a restriction system for use in an authority that operates to generate a content package that is downloaded to a device;

FIG. 3 shows one embodiment of a content package for use with one or more embodiments of a restriction system;

FIG. 4 shows a functional diagram of one embodiment of a restriction system for use in a device that operates to provide application level restrictions to applications and content rendered on the device;

FIG. 5 shows a data network that comprises one embodiment of a restriction system for use with a wireless device;

FIG. 6 shows one embodiment of a method for enforcing application level restrictions on applications and content rendered on a wireless device;

FIG. 7 shows one embodiment of an authority suitable for implementing one or more embodiments of a restriction system; and

FIG. 8 shows one embodiment of device suitable for implementing one or more embodiments of a restriction system.

### DETAILED DESCRIPTION

The following detailed description describes one or more embodiments of a restriction system that includes methods and apparatus to enforce application level restrictions on local and remote content rendered on a device. In one embodiment, the restriction system comprises a content viewer on the device to allow the device to access various network resources in an efficient and cost effective manner. The content viewer also enforces restrictions on downloaded content to prevent unauthorized operation of device systems or access to specific device information. The device may be any type of wired or wireless device, including but not limited to, a computer, a wireless telephone, a pager, a PDA, an email device, a tablet computer, or other type of wired or wireless device.

In one or more embodiments, the content viewer interacts with a runtime environment executing on the device that is used to simplify operation of the device, such as by providing generalized calls for device specific resources. One such runtime environment is the Binary Runtime Environment for Wireless™ (BREW™) software platform developed by QUALCOMM, Inc., of San Diego, Calif. In the following description, it will be assumed that the restriction system uses a content viewer implemented on a wireless device that is executing a runtime environment, such as the BREW software platform. However, one or more embodiments of the restriction system are suitable for use with other types of content viewers and/or runtime environments to enforce application level restrictions on local and remote content rendered on wired and wireless devices. Furthermore, the term “content” is use herein to describe any type of application, multimedia content, image file, executable, web page, script, document, presentation, message, or any other type of information that may be rendered on a device.

In one embodiment, the restriction system operates to enforce application level restrictions on content rendered on a wireless device by performing one or more of the following steps.

1. A wireless device downloads a content package associated with content to be viewed on the device. The content package includes a permissions list that describes the associated rights, restrictions, and privileges to be applied to the content. The content package also includes a content descriptor, which identifies the content, and a modification detection indicator (i.e., a digital signature) that binds the permissions list and the content descriptor.

2. When the user attempts to view the content, a content viewer application is activated. The content viewer application uses the digital signature to verify the authenticity of the permissions list and the content descriptor.

3. The content viewer application retrieves the content using the content descriptor and renders the content on the wireless device.

4. The rendered content is governed by the rules enforced on the content viewer application that were provided in the permissions list.

In one embodiment, the content descriptor contains the actual content data. For example, the content descriptor may be a document, image file, web page, or any other type of viewable content.

In one embodiment, the content descriptor is a content locator. For example, the content viewer operates as a network browser and the content descriptor is a content locator, such as a universal resource locator (URL). The content viewer navigates to the network address provided by the content descriptor and displays content pages retrieved from that location. In one embodiment, the content viewer operates to restrict the operation of the retrieved content pages according to the restrictions in the permissions list.

Permissions List

In one or more embodiments, the restriction system comprises a permissions list. The permissions list is a list of access rights, privileges, restrictions, or limitations that are applied to an application or content that is executed or rendered on a device. For example, when content and an associated permission list are installed on a device, the restriction system operates to allow the rendered content to access only the resources granted in the permission list.

In one embodiment, the developer of the application or content, a system administrator, or other authority, such as a carrier or device manufacturer, may create or provide input to creating the permissions list for the content. In another embodiment, a device server may be used to create the permissions list based on the input from authorities, entities, or parties involved with creating the application or content.

In one embodiment, a content developer submits the content to an authority. The authority reviews or evaluates the content and determines what privileges to assign to the content. The privileges then become part of the permissions list. Thus, the authority operates to approve the content and authorizes the associated rights provided in the permissions list.

It will be recognized by those skilled in the art that a device may further limit or grant access to device resources beyond the scope of the permissions list. For example, a user may not have rights to a resource on the device to which the application has been granted permission by the permissions list. Thus, the device may provide additional rights or limitations and may therefore grant or refuse to grant access to resources even if permission has been granted in the permissions list.

By associating the resources of a device to an application or content using a permission list, multiple permission lists may be created for use with the same application or content. Consequently, on different devices, different resources may be granted access to the same application or content.

Bindings

In one or more embodiments, the restriction system comprises a modification detection indicator that is used to provide a binding between a permissions list and a content descriptor. For example, any technique may be used to generate the modification detection indicator that binds the permissions list and the content descriptor. For example, in one embodiment, the modification detection indicator is a digital signature that is generated using the permissions list and the content descriptor. However, any type of signature, encoding, or other modification detection technique may be used to provide a binding between a permissions list and its associated content descriptor. Once the digital signature, permissions list, and content locator are transmitted to a wireless device, the device can use the signature to authenticate the permissions list and the content descriptor. For the purpose of this description, it will be assumed that entities transmitting the above-described information to the device are properly credentialed using any type of known credentialing or authentication technique, so that the receiving device can verify that it is receiving the information from a trusted source.

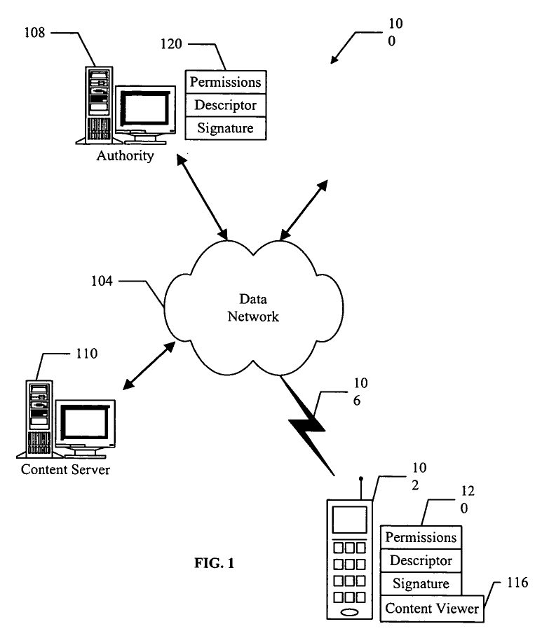

FIG. 1 shows a data network 100 that comprises one embodiment of a restriction system to enforce application level restrictions on local and remote content rendered on a wireless device. The network 100 comprises a wireless device 102 that communicates with a data network 104 via a wireless communication channel 106. The data network 104 subsumes a wired and wireless data network that is private, public or both. The network 100 also comprises an authority 108 that operates to provide services to the wireless device 102. For example, the wireless device 102 may be a wireless telephone, and the authority 108 may be part of a nationwide telecommunications network that provides telecommunication services to the device 102.

Also in communication with the network 104 is a content server 110. The content server 110 operates to provide content, such as multimedia content, to devices that are in communication with the network 104.

In one embodiment, the authority 108 comprises logic to generate a content package 120 that comprises a permissions list, a content descriptor and a digital signature. The permissions list describes rendering and resource access restrictions that are applied to applications or content identified by the content descriptor. The content descriptor may comprise actual content data, such as an image file or document. The content descriptor may also comprise a content locator that identifies the location of the content. For example, the content descriptor may identify an application or multimedia content located at the content server 110.

During operation of the system, the content package 120 is downloaded from the authority 108 to the device 102. The device 102 launches a content viewer 116 that operates to retrieve the content identified by the content descriptor and renders the content on the device 102 while applying the restrictions provided in the permissions list. For example, the content descriptor may be the actual content, which is rendered on the device by the content viewer 116. In another embodiment, the content descriptor is a content locator, which is used by the content viewer 116 to obtain the content for rendering on the device 102.

Because the permissions list is used to restrict the rendered content, the restriction system operates to protect the resources on the wireless device 102 from unauthorized access by the downloaded content, and thereby removes this burden from the device user. This allows the device user to download applications and content for use on the wireless device 102 without having to worry that the downloaded application or content may compromise the operation of the device or corrupt important information stored on the device.

The permissions list and content descriptor may be created by the authority 108 and bound together using the digital signature. For secure transmission of the content package 120, as well as any other data transfer, the authority 108 may incorporate various security techniques, such as encoding, encryption, credentials, authentication signatures, or other modification detection/authentication techniques to transmit the content package 120 to the device 102. Thus, the device can be sure it is receiving the content package 120 from a trusted source.

In one embodiment, the authority 108, and the server 110, are distinct network servers located at different physical locations. In another embodiment, the servers 108, 110 are located at the same physical location, and in still another embodiment, the servers 108 and 110 are the same server. Thus, in one or more embodiments, the restriction system may be implemented using virtually any network configuration having a variety of servers that operate to provide the functions of the restriction system described herein.

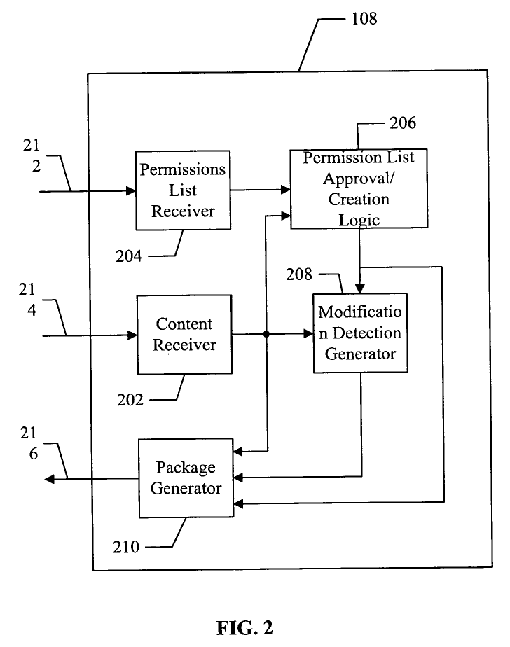

FIG. 2 shows a functional diagram of one embodiment of a restriction system for use in the authority 108 that operates to generate a content package that is downloaded to a device. In one embodiment, the authority 108 operates to approve a permissions list and generate the content package for download to a wireless device, for example, the device 102. The authority comprises a content receiver 202 that receives content 212 from the content server 110. The authority also comprises a permission list receiver 204 that receives a proposed permission list 214 from the content server 110. The approval/creation logic 206 takes the content 212 and the received permission list 214, evaluates the permissions list, and either approves or disapproves it. If no permission list is received, the logic 206 operates to generate one based on the content itself and other parameters. For example, based on the type of content or the source of the content, the logic 206 generates an associated permissions list. Once an approved permissions list is obtained, the permission list and content go to the modification detection generator 208. The generator 208 generates a modification detection indicator that binds the permissions list to the content. For example, the modification detection indicator may be a digital signature. Finally, a package generator 210 generates a content package 216 that incorporates the content 214, the permission list 212, and modification detection indicator.

In one embodiment, the content 214 is a content descriptor that identifies the content and its location. In another embodiment, the content 214 contains the actual application or content data. Once the content package is generated it is made available to the wireless device 102 which downloads it and renders it.

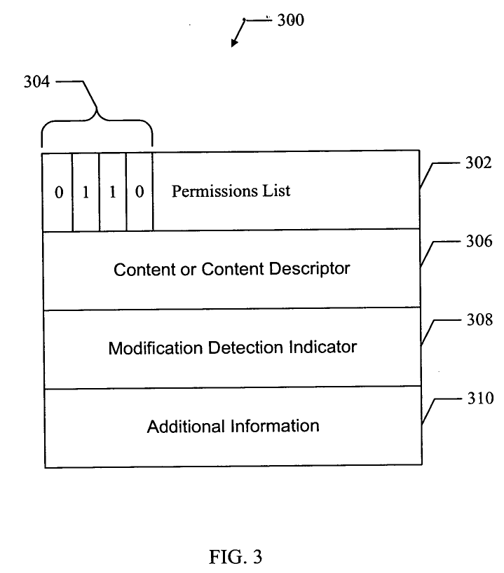

FIG. 3 shows one embodiment of a content package 300 for use with one or more embodiments of a restriction system. For example, the content package 300 shown in FIG. 3 may be the content package 120 shown in FIG. 1. The content package comprises a permissions list 302, actual content or a content descriptor 306, a modification detection indicator 308, and additional information 310.

The permissions list 302 comprises authorization settings 304 that indicate what restrictions, authorizations, or privileges are granted to the described application or content. For example, the authorization settings 304 comprises a series of bits that when set to a value of “1” grant a particular authorization to the content based on the position of the bit. For example, the first bit position may grant or deny access to selected device files, the second bit may grant or deny access to device hardware, such as a modem, and the third bit may grant or deny access to particular device settings, and so on. Thus, it is possible to grant or deny access to any type of device feature, function, setting or other information based on the bit settings in the permissions list 302.

In one embodiment, the content section 306 comprises a content descriptor that describes the application or content. For example, the content descriptor may comprise the actual application or content data downloaded to the device. For example, the content descriptor may include multimedia content, such as a MPEG or MIDI file, or may include an application, such as a gaming program. In another embodiment, the content descriptor may comprise a content locator (i.e., a URL) that identifies an application or content and/or its location on a data network that the device has access to. For example, the content descriptor may comprise the link (http://www.foo.com/videos/movie.mpg) that when accessed by the device, will cause “movie.mpg” to be downloaded to the device. In another embodiment, the content descriptor describes a set of content pages or addresses, a domain name, or any other type of information set. Thus, the content descriptor may be the actual application or content data, or a content locator that identifies the location of an application or content, or a content group that can be accessed and downloaded by the device.

In one embodiment, the modification detection indicator 308 comprises a digital signature and/or other security information that binds the permissions list with the content descriptor so that it is possible to verify their authenticity. Virtually any type of modification detection technique may be used to produce the modification detection indicator 308.

The additional information section 310 comprises additional information about the application or content that is associated with the content package. For example, the information section 310 may include file size, version, or other information relative to the content package 120 or the associated application or content. The additional information section 310 may also include license information associated with the application or content. For example, the license information may include the type of license granted, the date granted, the duration of the license, the cost of the license, or other license information.

In one embodiment, the content package is generated by the package generation logic 212 at the authority 108. However, it is also possible to generate all or part of the content package at other locations. For example, application or content developers may generate a permissions list for their application or content. In this case, the permissions list may be transmitted to the wireless device in several ways. For example, the application or content developer may transmit the permissions list to the authority 108 where it is evaluated, authorized and stored until the wireless device requests to download the associated content. In another example, a permissions list authorized by an authority is stored with the application or content at their respective servers. When the wireless device attempts to download the application or content, the associated permissions list is also downloaded to the wireless device. Regardless of the originating location of the content descriptor and the permissions list, the modification detection indicator 308 generated by the authority is used to bind them and to allow the device to authenticate them as unmodified originals. Furthermore, the authority operates to create, evaluate, and/or authorize the permissions list so that regardless of where it is stored, the permissions list only grants authorized permissions to the associated application or content.

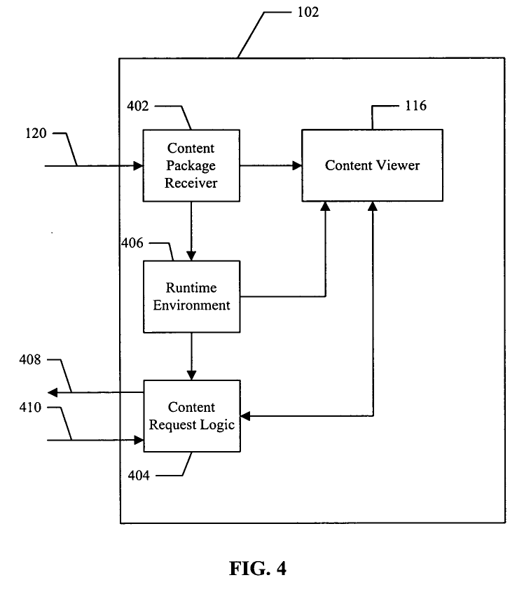

FIG. 4 shows a functional diagram of one embodiment of a restriction system for use in the device 102 that operates to provide application level restrictions to applications and content rendered on the device. In one embodiment, the content viewer 116 receives the content package 120 via a content receiver 402. The content package 120 is transferred to the content viewer 116, which takes the package apart and verifies the digital signature. If the content is not in the package, then the content viewer 116 fetches the content using content request logic 404. For example, the content descriptor may be an address where the content is stored. The content request logic 404 operates to transmit a request 408 to retrieve the content 410 from this address. Once the content is available, the content viewer 116 operates to render the content on the device and restrict the rendering operation based on the permission list 402 in the content package 120. In this embodiment the runtime/OS 406 is not directly involved and only supports the content viewer 116.

In another embodiment the content package is received by the receiver 402 and is handed off to the runtime/OS 406. The runtime/OS takes apart the package 120 and verifies the digital signature 408 in it. It also extracts the permission list 402. It then invokes the content viewer 116 handing it the content descriptor 406. It also restricts the operation of the content viewer 116 based on the permission list 402.

In a third embodiment the restrictions in the permission list are partly imposed by the content viewer 116 and partly by the runtime/OS 406.

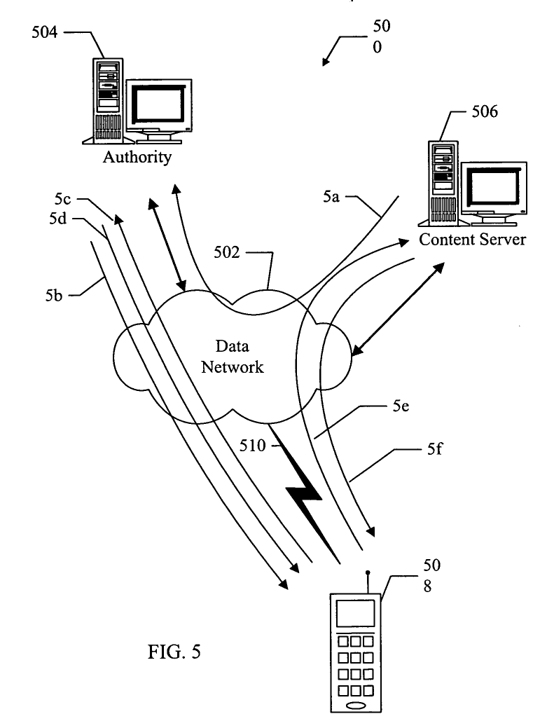

FIG. 5 shows a data network 500 that comprises one embodiment of a restriction system for use with a wireless device. The network 500 comprises a general purpose data network 502 that includes connections to an authority 504 and a content server 506. The data network 502 may be private or public or both and may be wired or wireless or both. The authority 504 may be a carrier server, device server, or other authority. The network 502 also communicates with a wireless device 508 via a wireless communication channel 510. For this description, it will be assumed that wireless device 508 includes a runtime environment, such as that provided by the BREW software platform.

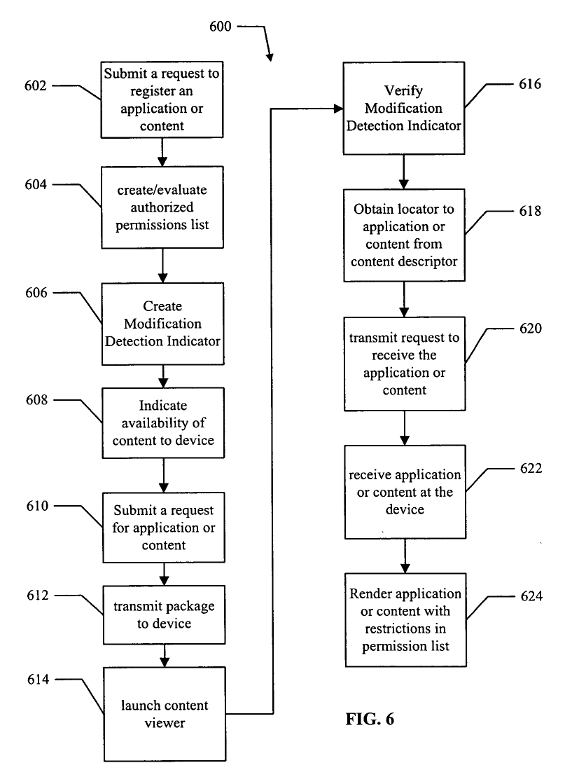

FIG. 6 shows one embodiment of a method 600 for enforcing application level restrictions on applications and content rendered on a wireless device. For example, the method 600 is suitable for use with the network 500 shown in FIG. 5. Therefore, for added clarity, the following detailed description of the method 600 includes additional references to the network 500.

Referring now to FIG. 6, the method 600 begins at block 602, when a content server submits a request to the restriction system to authorize content so that a wireless device may render it without concern. For example, the content server 506 submits a request, as shown at path 5a, to register content with the authority 504. The request may include a content descriptor that comprises the actual content data, or a content locator, and may also include a permissions list for the content. In one embodiment, if the permissions list is not provided, the authority 504 generates the permissions list for the content.

At block 604, the authority operates to create/evaluate an authorized permissions list. For example, in one embodiment, the authority 504 evaluates the content and/or other information related to the content and generates an authorized permissions list that is associated with the content. In another embodiment, the content provider 506 provides a permissions list and the authority operates to evaluate the provided permissions list and determine whether the permissions list should be authorized. Thus, any privileges granted to the content via the permissions list are first authorized by the authority 504.

At block 606, the authority generates a modification detection indicator that binds the content descriptor and the permissions list. For example, in one embodiment, the authority 504 generates a digital signature using the content descriptor and the permissions list. However, any other modification detection technique could be used. In one embodiment, the content descriptor, permissions list and the digital signature form a content package that may be transmitted to a wireless device or any other entities on the network 502. The content descriptor may be the actual content or a content locator.

At block 608, an indication is provided to the wireless device that the content is available for download. For example, the device 508 may browse a catalog of available content provided by the authority 504. In one embodiment, the authority 504 transmits an icon, as shown at path 5b, for display on the wireless device 508 that the user may select to access the content. In one embodiment, the runtime environment executing on the device 508 receives and displays the icon to the device user.

At block 610, the wireless device user submits a request to the authority to download an application or multimedia content. For example, the device user selects the icon displayed on the device 508 and the runtime environment executing on the device 508 transmits a request, as shown at path 5c, to the authority 504 using the network 502 to download the application or multimedia content associated with the displayed icon.

At block 612, in response to the request for content, a content package is transmitted to the device. For example, the authority 504 responds to the device's 508 request by transmitting to the device 508 (as shown at path 5d) a content package that includes the content descriptor, the permissions list and the digital signature. The content package may also include additional information about the content or additional security information used, such as a key or credential to verify that the device has received the content package from the authority 504. For example, the credential allows the device to verify that it has received the content package from a trusted source.

At block 614, the runtime environment running on the wireless device launches a content viewer that operates to process the content package to allow the device user to view the requested content. For example, the BREW runtime environment running on the wireless device 508 launches the content viewer 116.

At block 616, the content viewer uses the digital signature to verify the authenticity of the permissions list and the content descriptor. For example, the content viewer 116 uses the permissions list and the content descriptor to generate a second digital signature that is compared to the digital signature received from the authority 504 in the content package. Assuming the permissions list and the content descriptor are authentic, the method proceeds to block 616.

At block 618, the content viewer processes the content package and determines that it contains a content descriptor that identifies the content data. For example, the content descriptor is an address (URL) to the content, which is located at the content server 506.

At block 620, the content viewer transmits a request to the content server to receive the content. For example, the content viewer 514 transmits a request to the content server 506 over the wireless network 502, as shown at path 5e. The request is a request to receive the content pointed to by the content descriptor.

At block 622, in response to the request, the content server transmits the content to the wireless device. For example, the content server 506 receives the request, and in response, transmits the content identified by the content descriptor to the wireless device 508, as shown at path 5f.

At block 624, the content viewer then renders the content on the device. When the content is rendered, the content viewer uses the restrictions provided in the permission list to apply to the content so that the content is restricted from accessing selected functions, features, device settings, and/or specific information stored on the device. Virtually any type of resource or operational restriction may be provided based on the permissions in the permissions list. Thus, the restriction system allows the device 508 to download content from remote servers and render the content knowing that the restriction system has restricted the content so that device resources or information will not be access without proper authorization. The restriction of the content occurs without burdening the device user with having to determine when and how to restrict the content.

Although the method 600 describes the use of a content package that comprises a permissions list, content descriptor and digital signature, in one or more embodiments, a content package is not used. For example, the permissions list, content descriptor, and modification detection indicator may be transmitted to the wireless device from the same or different sources. Thus, a content provider may transmit the content descriptor, a device server may transmit the permissions list, and an authority may transmit the modification detection indicator. In another embodiment, the modification detection indicator is incorporated into the permissions list and/or the content descriptor. Virtually any combination of the information is possible, and the information may be transmitted to the device from one or any number of transmitting sources.

In one embodiment, the wireless device operates to authenticate that the modification detection indicator was generated by the proper authority. For example, any type of encoding, encryption, credentials, etc., may be used to authenticate the modification detection indicator. Once the modification detection indicator is authenticated, it is used to authenticate the permissions list and the content descriptor. Thus, no matter how the information is transmitted to the device, the authentication process allows the device to verify that it has the authentic information, which may be used to safely render the content on the device.

The method 600 is intended to be illustrative and not limiting of the operation of the various embodiments described herein. For example, it would be obvious to one with skill in the art to make minor changes, additions or deletions to any of the described methods. Furthermore, the described method steps may be combined, rearranged or reordered without deviating from the scope of the described embodiments.

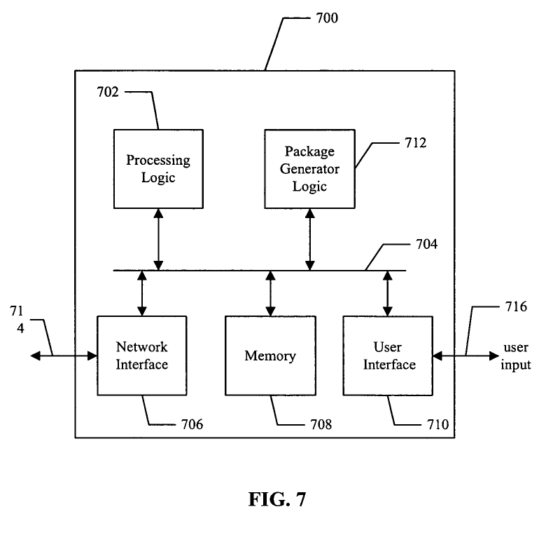

FIG. 7 shows one embodiment of an authority 700 suitable for implementing one or more embodiments of a restriction system as described herein. The authority 700 and all its functional blocks may be implemented as software, hardware, or both. In one embodiment the functional blocks are implemented as instructions stored in memory 708 and executed by processing logic 702. In another embodiment, some of the functional blocks such as the package generator 712 may be implemented as special purpose hardware (i.e., a gate array) or any other hardware, logic, or circuit capable of providing the described functionality.

A network interface 706 operates to provide communications 714 between the authority and a data network. The network interface 706 allows the authority 700 to communicate with content servers, devices, and other network entities.

A user interface 710 operates to provide interaction between the authority 700 and a user via the user input 716. The user interface 710 is used to allow a user to communicate operating parameters to the processing logic 702.

In one embodiment, the package generator logic 712 operates to receive content and a permissions list, evaluate the permissions list, and approve or disapprove it. In another embodiment, the package logic 712 operates to generate a permissions list based on the received content and other parameters. Once an authorized permissions list is obtained, the logic 712 operates to binding the permissions list and the content using a modification detection indicator, such as a digital signature. The content, permissions list, and digital signature are then combined into a content package that is transmitted to a device via the network interface 706.

It should be noted that the device 700 illustrates just one embodiment of an authority suitable for implementing a restriction system as described herein. It is also possible to implement a restriction system using different functional elements, rearranging the elements, or using a different type of device. Thus, the embodiments described herein are not limited to the implementation shown in FIG. 7.

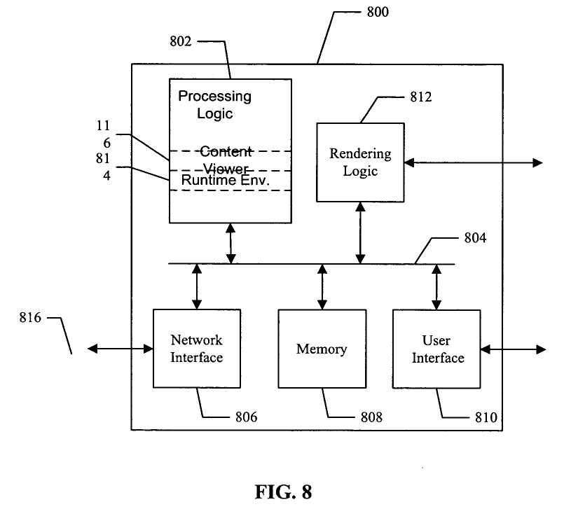

FIG. 8 shows one embodiment of device 800 suitable for implementing one or more embodiments of a restriction system as described herein. The device 800 comprises processing logic 802, internal bus 804, network interface 806, rendering logic 812, memory 808, and user interface 810. In one embodiment, all the functional blocks of the device 800 are implemented as instructions stored in the memory 808 and executed by processing logic 802. In another embodiment, some of the functional blocks such as the content viewer 116 may be implemented as special purpose hardware (i.e., a gate array) connected to the bus 804, or as any other hardware circuit capable of providing the required functionality. The network interface 806 may use any means of transferring, storing or copying data including a network connection 816 that may be coupled to local or remote networks, devices, or systems.

In one embodiment, the processing logic 802 executes program instructions stored in the memory 808 that cause a runtime environment 814 to be activated. The runtime environment 814 processes a content package received via the network interface 806, and in response, activates a content viewer 116. The content viewer 116 operates to render content contained in the content package using the rendering logic 812. The content viewer renders the content using restrictions based on a permissions list provided in the content package. In one embodiment, the content package includes a content descriptor that identifies the location of the content to be rendered. The content viewer 116 uses the content descriptor to obtain the content from the specified location via the network interface 806. Once obtained, the content is rendered via the rendering logic 812.

It should be noted that the device 800 illustrates just one embodiment of a device suitable for implementing a restriction system as described herein. It is also possible to implement a restriction system using different functional elements, rearranging the elements, or using a different type of device. Thus, the embodiments described herein are not limited to the implementation shown in FIG. 8.

Restriction Override

In one embodiment, the device user may override access rights or restrictions provided in the permissions list. For example, by providing specific user inputs, the user may override access rights provided in the permissions list to prevent an application or content from accessing a specific device resource or stored information. Thus, the device user maintains the ability to control access to device resources even if access to those resources is not granted in the permissions list.

A restriction system has been described that includes methods and apparatus to enforce application level restrictions on local and remote applications and content rendered on a wireless device. The system is suitable for use with all types of wireless devices and is especially well suited for use with mobile telephones to provide access to a wide range of network resources while providing restrictions to protect feature, functions, settings, information and other device systems.

Accordingly, while one or more embodiments of methods and apparatus for enforcing application level restrictions have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

I claim:

1. A method for use in a device to enforce restrictions on content rendered by the device, the method comprising:
receiving a permissions list associated with the content;
receiving a content descriptor that identifies the content;
receiving a modification detection indicator that was created by an authority, wherein the modification detection indicator binds the permissions list and the content descriptor;
retrieving the content identified by the content descriptor; and
rendering the content on the device, wherein the content is restricted based on the permissions list.

2. The method of claim 1, wherein the step of retrieving comprises retrieving the content from a data network at a location identified by the content descriptor.

3. The method of claim 1, wherein the content descriptor includes the content and the step of retrieving comprises retrieving the content from the content descriptor.

4. The method of claim 1, wherein the step of receiving the permissions list comprises receiving the permissions list from the authority.

5. The method of claim 1, wherein the step of receiving the content descriptor comprises receiving the content descriptor from the authority.

6. The method of claim 1, wherein the step of receiving the permissions list comprises receiving the permissions list from a content provider.

7. The method of claim 1, wherein the modification detection indicator is a digital signature.

8. The method of claim 1, wherein the device is a wireless device.

9. A device for rendering content, comprising:
receiving logic that operates to obtain a permissions list, content descriptor, and a modification detection indicator that was created by an authority;
rendering logic that operates to verify the modification detection indicator, obtain content identified by the content descriptor, and render the content on the device, wherein the content is restricted based on the permissions list.

10. The device of claim 9, wherein the device is a wireless device.

11. The device of claim 9, wherein the modification detection indicator is a digital signature.

12. The device of claim 9, wherein the content descriptor includes the content and the rendering logic operates to obtain the content from the content descriptor.

13. A device that operates to enforce restrictions on downloadable content that is rendered on the device, the device comprising:
means for receiving a permissions list associated with the content;
means for receiving a content descriptor that identifies the content;
means receiving a modification detection indicator that was created by an authority, wherein the modification detection indicator binds the permissions list and the content descriptor;
means for retrieving the content identified by the content descriptor; and
means for rendering the content on the device, wherein the content is restricted based on the permissions list.

14. The device of claim 13, wherein the means for retrieving comprises means for retrieving the content from a data network at a location identified by the content descriptor.

15. The device of claim 13, wherein the content descriptor includes the content and the means for retrieving comprises means for retrieving the content from the content descriptor.

16. The device of claim 13, wherein the means for receiving the permissions list comprises means for receiving the permissions list from the authority.

17. The device of claim 13, wherein the means for receiving the content descriptor comprises means for receiving the content descriptor from the authority.

18. The device of claim 13, wherein the means for receiving the permissions list comprises means for receiving the permissions list from a content provider.

19. The device of claim 13, wherein the modification detection indicator is a digital signature.

20. The device of claim 13, wherein the device is a wireless device.

21. A computer-readable media comprising instructions that when executed by a processor in a wireless device enforces restrictions on content rendered by the device, the computer readable media comprising:
instructions for receiving a permissions list associated with the content;
instructions for receiving a content descriptor that identifies the content;
instructions receiving a modification detection indicator that was created by an authority, wherein the modification detection indicator binds the permissions list and the content descriptor;
instructions for retrieving the content identified by the content descriptor; and
instructions for rendering the content on the device, wherein the content is restricted based on the permissions list.

22. The computer readable media of claim 21, wherein the instructions for retrieving comprises instructions for retrieving the content from a data network at a location identified by the content descriptor.

23. The computer readable media of claim 21, wherein the content descriptor includes the content and the instructions for retrieving comprises instructions for retrieving the content from the content descriptor.

24. The computer readable media of claim 21, wherein the instructions for receiving the permissions list comprises instructions for receiving the permissions list from the authority.

25. The computer readable media of claim 21, wherein the instructions for receiving the content descriptor comprises instructions for receiving the content descriptor from the authority.

26. The computer readable media of claim 21, wherein the instructions for receiving the permissions list comprises instructions for receiving the permissions list from a content provider.

27. The computer readable media of claim 21, wherein the modification detection indicator is a digital signature.

28. A method for generating a content package that is used to enforce restrictions on content rendered on a device, the method comprising:
authorizing a permissions list associated with the content;
receiving a content descriptor that describes the content; and
generating a modification detection indicator that binds the permissions list and the content descriptor.

29. The method of claim 28, wherein the step of authorizing the permissions list comprises generating the permissions list.

30. The method of claim 28, wherein the step of receiving the content descriptor comprises receiving the content descriptor which includes the content.

31. The method of claim 28, wherein the step of generating a modification detection indicator is a step of generating a digital signature.

32. Apparatus for generating a content package that is used to enforce restrictions on content rendered on a device, the apparatus comprising:
approval logic that operates to authorize a permissions list associated with the content;
receiving logic that operates to receive a content descriptor that describes the content; and
generating logic that operates to generate a modification detection indicator that binds the permissions list and the content descriptor.

33. The apparatus of claim 32, wherein the approval logic comprises logic to generate the permissions list.

34. The apparatus of claim 32, wherein the content descriptor includes the content.

35. The apparatus of claim 32, wherein the generating logic comprises logic to generate a digital signature as the detection modification indicator.

36. Apparatus for generating a content package that is used to enforce restrictions on content rendered on a device, comprising:
means for authorizing a permissions list associated with the content;
means for receiving a content descriptor that describes the content; and
means for generating a modification detection indicator that binds the permissions list and the content descriptor.

37. The apparatus of claim 36, wherein the means for authorizing the permissions list comprises means for generating the permissions list.

38. The apparatus of claim 36, wherein the content descriptor includes the content.

39. The apparatus of claim 36, wherein the means for generating a modification detection indicator comprises means for generating a digital signature.

40. A computer-readable media comprising instructions that when executed by a processor generate a content package that is used to enforce restrictions on content rendered on a device, the computer readable media comprising:
instructions for receiving a permissions list associated with the content;
instructions for receiving a content descriptor that identifies the content; and
instructions generating a modification detection indicator that binds the permissions list and the content descriptor.

41. The computer readable media of claim 40, wherein the instructions for receiving the permissions list comprise instructions for generating the permissions list.

42. The computer readable media of claim 40, wherein the content descriptor includes the content.

43. The computer readable media of claim 40, wherein the instructions for generating a modification detection indicator comprise instructions for generating a digital signature.

44. The computer readable media of claim 40, further comprising instructions for authorizing the permissions list.
